(19) United States
(12) Patent Application Publication
(10) Pub. No.: US 2025/0220327 A1
(43) Pub. Date: Jul. 3, 2025

(54) WALL-MOUNTED AUDIO DEVICE

(71) Applicant: Shenzhen Dekangxing Technology Co., LTD, Shenzhen (CN)

(72) Inventors: Pengfeng Zhang, Shenzhen (CN); Jie Zhong, Shenzhen (CN)

(21) Appl. No.: 19/087,461

(22) Filed: Mar. 22, 2025

(30) Foreign Application Priority Data
Jan. 23, 2025 (CN) 202520157803.1

(51) Int. Cl. H04R 1/02; H04R 1/28

(52) U.S. Cl. CPC H04R 1/023; H04R 1/025; H04R 1/028; H04R 1/2826; H04R 1/2888; H04R 2499/15

(57) ABSTRACT

A wall-mounted audio device is provided, including: a display component; a wall-mounted box body, wherein a front panel is provided with a rim region and a display region; the display component is arranged in the display region; a rear panel of the wall-mounted box body is provided with a wall connector; a speaker module, arranged inside the wall-mounted box body a sound output end of the speaker module faces the sound outlet hole; and an mesh. The mesh is detachably connected to the front panel of the wall-mounted box body. The display component is a liquid crystal display screen. The speaker module includes a speaker module housing and one or more transducers designed on the speaker module housing. The speaker module housing is provided with a bass enhancement port. The rear panel of the wall-mounted box body is provided with a wire receiving slot.

### TECHNICAL FIELD

The present disclosure relates to the technical field of audible devices, and in particular, to a wall-mounted audio device.

### BACKGROUND

A wall-mounted audio device is different from a conventional audio device. The wall-mounted audio device is usually fixed and hung in a designated wall position, commonly found in a museum, a practice room, a science museum, an art gallery, and other places. Certainly, the wall-mounted audio device can also be used in families. In the prior art, the wall-mounted audio device is not only often used as an audio playback device, but also combined with some exhibits. For example, for the wall-mounted audio device in the museum, if exhibited cultural relic pictures are integrated with the wall-mounted audio device, the wall-mounted audio device plays explanatory audios of corresponding exhibits. In a family scene, a user can customize exhibited pictures that are combined with the wall-mounted audio device.

At present, for a wall-mounted audio device, such as an anti-fixed type multifunctional mural audio device disclosed in patent application No. CN201520219403.5, a speaker and a front panel carrying a mural are arranged in separate regions, and a through hole for outputting a sound of a transducer and a dust cover are provided in a box body. This greatly affects a simple appearance.

With the development of a display screen technology, the wall-mounted audio device can be made thinner when a lighter and thinner display screen is used to display murals. In order to achieve a front-facing appearance, the screen is usually made larger or rimless, and the speaker can only output a sound toward a back part, a side surface, or a bottom. When entering human ears through reflection or diffraction, middle to high frequencies have already been significantly attenuated and delayed, which affects the overall sound quality. In addition, if the audio device outputs a sound toward a front part as described above, the appearance is affected.

### SUMMARY

For the above problems, the present disclosure mainly provides a wall-mounted audio device, and aims at solving the technical problems in the background section.

To achieve the above objectives, the present disclosure provides a wall-mounted audio device, including:
a display component;
a wall-mounted box body, wherein a front panel of the wall-mounted box body is provided with a rim region and a display region; the display component is arranged in the display region; a rear panel of the wall-mounted box body is provided with a wall connector;
a speaker module, wherein the speaker module is arranged inside the wall-mounted box body, and a sound outlet hole corresponding to the speaker module is provided in the rim region; a sound output end of the speaker module faces the sound outlet hole; and
a mesh, wherein an area of the mesh is matched with an area of the rim region; and the mesh is detachably connected to the front panel of the wall-mounted box body.

Further, the mesh is any one of cotton cloth cover, a silk cover, or a synthetic fiber cover.

Further, the display component is any one of a liquid crystal display screen, a photo, an oil painting, an ink painting, a poster, calligraphy works, an image print, and an mesh printed with a customized pattern.

Further, the wall-mounted audio device includes a mesh bracket; the mesh bracket is arranged between the mesh and the wall-mounted box body; the mesh is detachably connected to the front panel of the wall-mounted box body through the mesh bracket; and the mesh bracket is provided with a sound transmission hole corresponding to the speaker module.

Further, the mesh bracket is connected to the front panel of the wall-mounted box body in a magnetic suction manner.

Further, the mesh bracket is connected to the front panel of the wall-mounted box body through a hook and loop fastener.

Further, the wall-mounted audio device includes a vibration isolation damping clement; and the vibration isolation damping element is arranged at a joint between the speaker module and the wall-mounted box body.

Further, two groups of speaker modules are provided, which are symmetrically distributed on left and right sides.

Further, the speaker module includes one or more transducers and a speaker module housing, and a bass enhancement port is designed on the speaker module housing.

Further, the rear panel of the wall-mounted box body is provided with a wire receiving slot; and heat dissipation holes are provided in the rear panel and a side panel of the wall-mounted box body.

Compared with the prior art, the wall-mounted audio device provided by the present disclosure has the advantages that a blank space around the display component is retrofitted into the attractive mesh; a customization design can be performed on the mesh, such as changing a color and printing a pattern and characters; and the speaker module is hidden behind, which beautifies the appearance and ensures a sound being output from a front surface, so that a high-quality playback effect that the sound can directly reach human ears is achieved. The speaker module is detachably connected to the wall-mounted box body, making it very convenient for a user to change different styles at proper time and improving the playability of the product and the diversity of the appearance.

### BRIEF DESCRIPTION OF THE DRAWINGS

FIG. 1 is a schematic diagram of an exploded structure of a wall-mounted audio device according to the present disclosure.

FIG. 2 is a schematic diagram of a front panel and a side panel of a wall-mounted box body of a wall-mounted audio device according to the present disclosure.

FIG. 3 is a schematic diagram of a rear panel of a wall-mounted box body of a wall-mounted audio device according to the present disclosure.

FIG. 4 is a schematic structural diagram of a speaker module of a wall-mounted audio device according to the present disclosure.

Numerals in the drawings: 1: display component; 2: wall-mounted box body; 210: rim region; 211: sound outlet hole; 220: display region; 230: wall connector; 240: wire receiving slot; 250: heat dissipation hole; 3: speaker module; 310: speaker module housing; 311: bass enhancement port; 320: transducer; 4: mesh; 5: mesh bracket; 510: sound transmission hole; and 6: vibration isolation damping element.

### DETAILED DESCRIPTION OF THE EMBODIMENTS

The technical solutions in the embodiments of the present disclosure are clearly and completely described below with reference to the accompanying drawings in the embodiments of the present disclosure. Apparently, the described embodiments are merely some embodiments of the present disclosure, rather than all of the embodiments. All other embodiments obtained by a person of ordinary skill in the art based on the embodiments of the present disclosure without making creative efforts shall fall within the protection scope of the present disclosure. It can be understood that the drawings are only for reference and illustration purposes and are not intended to limit the present disclosure. The connection relationship shown in the accompanying drawings is only for the sake of clear description and does not limit a connection method.

It should be noted that when an assembly is considered to be “connected” to another assembly, the assembly can be directly connected to the another assembly or there may be an intermediate assembly. Unless otherwise defined, all technical and scientific terms used herein have the same meaning as those commonly understood by a person skilled in the art to which the present disclosure belongs. It should be also noted that unless otherwise specified and limited, the terms “mount”, “connect”, and “connection” should be broadly understood. For example, it can be a fixed connection, detachable connection, integrated connection, mechanical connection, electrical connection, or internal communication between two elements. For those of ordinary skill in the art, the specific meanings of the aforementioned terms in the present disclosure can be understood based on specific conditions. Terms used in the specification of the present disclosure herein are merely intended to describe objectives of the specific embodiments, but are not intended to limit the present disclosure.

It should also be noted that in the descriptions of the present disclosure, orientations or positional relationships indicated by the terms “center”, “upper”, “lower”, “left”, “right”, “vertical”, “horizontal”, “inner”, “outer”, and the like are orientations or positional relationships as shown in the drawings, and are only for the purpose of facilitating and simplifying the descriptions of the present disclosure instead of indicating or implying that devices or elements indicated must have particular orientations, and be constructed and operated in the particular orientations, so that these terms are not construed as limiting the present disclosure. In addition, the terms “first”, “second”, and “third” are only for the purpose of description, and may not be understood as indicating or implying the relative importance.

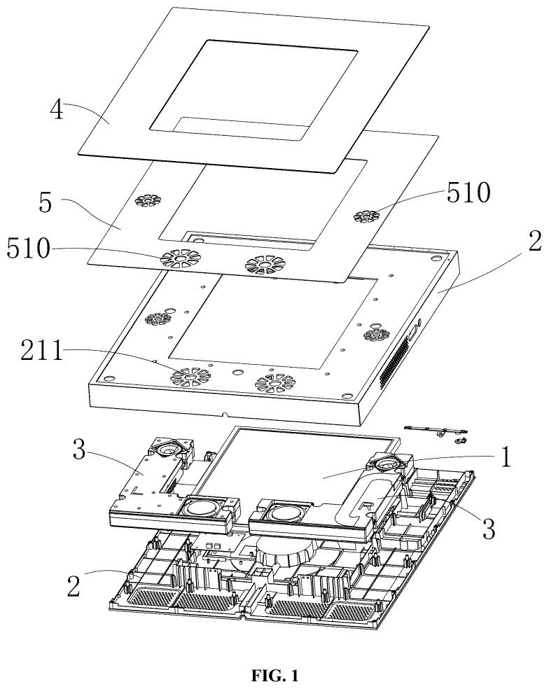

Referring to FIG. 1 to FIG. 4, this embodiment provides a wall-mounted audio device, including:
a display component 1;
a wall-mounted box body 2, wherein a front panel of the wall-mounted box body 2 is provided with a rim region 210 and a display region 220; the display component 1 is arranged in the display region 220; a rear panel of the wall-mounted box body 2 is provided with a wall connector 230;
a speaker module 3, wherein the speaker module 3 is arranged inside the wall-mounted box body 2, and a sound outlet hole 211 corresponding to the speaker module 3 is provided in the rim region 210; a sound output end of the speaker module 3 faces the sound outlet hole 211; and
an mesh 4, wherein an area of the mesh 4 is matched with an area of the rim region 210; and the mesh 4 is detachably connected to the front panel of the wall-mounted box body 2.

Since it is a fabric, the mesh 4 has a breathable and sound-transmitting effect, with a sound transmission rate that does not affect outputting of a sound by the speaker module 3. The mesh 4 can cover the rim region 210 of the wall-mounted box body 2, which plays a role of protecting the front panel of the wall-mounted box body 2 and is beautiful and tidy, thus forming a decorative rim for the display component 1. The mesh 4 can be added with innovative elements and techniques to enhance the texture of the wall-mounted audio device and beautify the appearance.

In some embodiments, the display component 1 may be a photo, an oil painting, an ink painting, a poster, calligraphy works, an image print, or another object. The display component 1 can be made of the same material as the mesh 4 and is integrally connected to the mesh 4. The display component 1 and the mesh 4 can be located on the same plane which is printed with a customized pattern. Then, the mesh 4 can be detachably connected to the front panel of the wall-mounted box body 2, and a style matched with and corresponding to the display component 1 for exhibition can be selected to enhance a user experience.

The wall-mounted audio device designed in this way solves the drawback that in the prior art, the sound transmission hole for outputting a sound and the dust cover on the front panel of the wall-mounted audio device affect the appearance, and solves the problem of poor sound quality because a speaker of the light and thin wall-mounted audio device can only output a sound toward a back part, a side surface, or a bottom.

Preferably, the mesh 4 is any one of cotton cloth cover, a silk cover, or a synthetic fiber cover.

The cotton cloth cover has good softness and breathability, and can provide effective dust and moisture prevention effects for the speaker module 3.

Compared the cotton cloth cover, the silk cover is smoother and softer, and has a better hand feel and luster. The high-end luxury texture of the wall-mounted audio device is enhanced.

The synthetic fiber cover has wear resistance, toughness, and tear resistance, and has a long service life.

Preferably, the display component 1 is a liquid crystal display screen.

In some embodiments, a main control panel (not shown) is further arranged inside the wall-mounted box body 2. The main control panel is connected to the liquid crystal display screen and the speaker module 3 to control content displayed on the liquid crystal display screen and audios played by the speaker module 3. The main control panel is further provided with a wireless module that can be controlled by an external control terminal and perform data transmission.

Referring to FIG. 1, the wall-mounted audio device includes a mesh bracket 5. The mesh bracket 5 is arranged between the mesh 4 and the wall-mounted box body 2. The mesh 4 is detachably connected to the front panel of the wall-mounted box body 2 through the mesh bracket 5. The mesh bracket 5 is provided with a sound transmission hole 510 corresponding to the speaker module 3.

The sound transmission hole 510 is communicated to the sound outlet hole 211.

Preferably, the mesh bracket 5 and the mesh 4 are of an integrally connected structure. On the one hand, the mesh bracket 5 is configured to flatten the mesh 4, and on the other hand, it is convenient for detachable connection between the mesh 4 and the front panel of the wall-mounted box body 2.

In some embodiments, the mesh bracket 5 is connected to the front panel of the wall-mounted box body 2 in a magnetic suction manner.

In some embodiments, the mesh bracket 5 is connected to the front panel of the wall-mounted box body 2 through a hook and loop fastener.

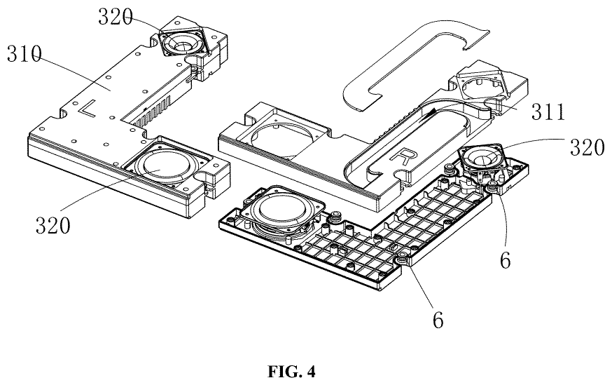

Referring to FIG. 4, the wall-mounted audio device includes a vibration isolation damping element 6. The vibration isolation damping element 6 is arranged at a joint between the speaker module 3 and the wall-mounted box body 2.

The vibration isolation damping element 6 is configured to prevent vibrations generated during operation of the speaker module 3 from being transmitted to the display component 1, causing the display component 1 and content displayed on the display component 1 to shake.

Referring to FIG. 1 and FIG. 4, two groups of speaker modules 3 are provided, which are symmetrically distributed on left and right sides.

This setting can achieve a left and right stereo playback effect for the wall-mounted audio device.

Referring to FIG. 1 and FIG. 4, the speaker module 3 includes a speaker module housing 310 and one or more transducer 320 designed on the speaker module housing 310. The speaker module housing 310 is provided with an bass enhancement port 311.

When a plurality of transducers 320 are included, a bass playback effect with higher sound quality can be achieved.

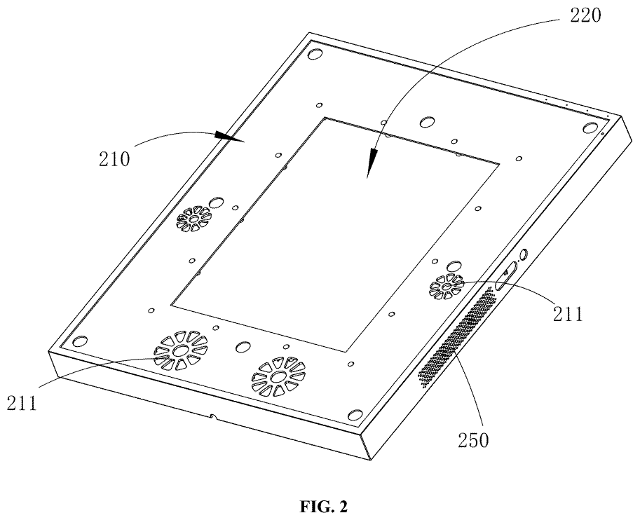

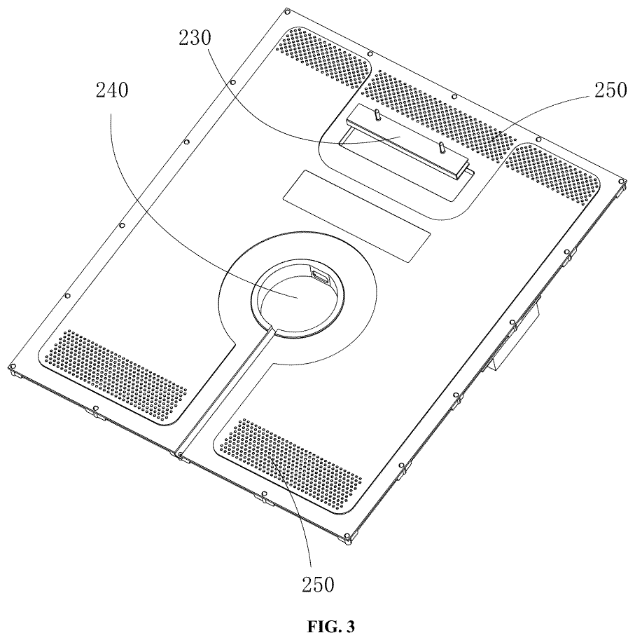

Referring to FIG. 2 and FIG. 3, the rear panel of the wall-mounted box body 2 is provided with a wire receiving slot 240. Heat dissipation holes 250 are provided in the rear panel and a side panel of the wall-mounted box body 2.

The wire receiving slot 240 can guide and store external wires and cables, to avoid impact on the flatness of the rear panel of the wall-mounted box body 2. The wall-mounted box body 2 is connected to a wall through the wall connector 230, and the back panel fits more smoothly with the wall.

In summary, according to the wall-mounted audio device provided by the present disclosure, a blank space around the display component 1 is retrofitted into the attractive mesh 4; a customization design can be performed on the mesh 4, such as changing a color and printing a pattern and characters; and the speaker module 3 is hidden behind, which beautifies the appearance and ensures a sound being output from a front surface, so that a high-quality playback effect that the sound can directly reach human ears is achieved. The speaker module 3 is detachably connected to the wall-mounted box body 2, making it very convenient for a user to change different styles at proper time and improving the playability of the product and the diversity of the appearance.

In this specification and the claims of the present disclosure, the term “include/contain”, “has/include”, and their variations are used to specify the presence of stated features, values, steps, or components, but do not exclude the presence or addition of one or more other features, values, steps, components, or combinations thereof.

Some features of the present disclosure are described in different embodiments for clarity. However, these features can also be described in combination with a single embodiment. On the contrary, some features of the present disclosure are described only in a single embodiment for simplicity. However, these features can also be described separately or in any suitable combination in different embodiments.

The above describes the preferred embodiments of the present disclosure and is not intended to limit the present disclosure. Any modification, equivalent replacement, and improvement made within the spirit and scope of the present disclosure shall fall within the protection scope of the present disclosure.

What is claimed is:

1. A wall-mounted audio device, comprising:
a display component;
a wall-mounted box body, wherein a front panel of the wall-mounted box body is provided with a rim region and a display region; the display component is arranged in the display region; a rear panel of the wall-mounted box body is provided with a wall connector;
a speaker module, wherein the speaker module is arranged inside the wall-mounted box body, and a sound outlet hole corresponding to the speaker module is provided in the rim region; a sound output end of the speaker module faces the sound outlet hole; and
an mesh, wherein an area of the mesh is matched with an area of the rim region; and the mesh is detachably connected to the front panel of the wall-mounted box body.

2. The wall-mounted audio device according to claim 1, wherein the mesh is any one of cotton cloth cover, a silk cover, or a synthetic fiber cover.

3. The wall-mounted audio device according to claim 1, wherein the display component is any one of a liquid crystal display screen, a photo, an oil painting, an ink painting, a poster, calligraphy works, an image print, and an mesh printed with a customized pattern.

4. The wall-mounted audio device according to claim 1, comprising a mesh bracket, wherein the mesh bracket is arranged between the mesh and the wall-mounted box body; the mesh is detachably connected to the front panel of the wall-mounted box body through the mesh bracket; and the mesh bracket is provided with a sound transmission hole corresponding to the speaker module.

5. The wall-mounted audio device according to claim 4, wherein the mesh bracket is connected to the front panel of the wall-mounted box body in a magnetic suction manner.

6. The wall-mounted audio device according to claim 4, wherein the mesh bracket is connected to the front panel of the wall-mounted box body through a hook and loop fastener.

7. The wall-mounted audio device according to claim 1, comprising a vibration isolation damping element, wherein the vibration isolation damping element is arranged at a joint between the speaker module and the wall-mounted box body.

8. The wall-mounted audio device according to claim 1, wherein two groups of speaker modules are provided, which are symmetrically distributed on left and right sides.

9. The wall-mounted audio device according to claim 1, wherein the speaker module comprises a speaker module housing and one or more transducers mounted on the speaker module housing; and the speaker module housing is provided with a bass enhancement port.

10. The wall-mounted audio device according to claim 1, wherein the rear panel of the wall-mounted box body is provided with a wire receiving slot; and heat dissipation holes are provided in the rear panel and a side panel of the wall-mounted box body.
